(19) United States
(12) Patent Application Publication
(10) Pub. No.: US 2025/0076921 A1
(43) Pub. Date: Mar. 6, 2025

(54) DISPLAY DEVICE

(71) Applicant: Funai Electric Co., Ltd., Osaka (JP)

(72) Inventor: Riki YAMASHITA, Osaka (JP)

(21) Appl. No.: 18/820,937

(22) Filed: Aug. 30, 2024

(30) Foreign Application Priority Data
Sep. 6, 2023 (JP) 2023-144564

(51) Int. Cl. G06F 1/16

(52) U.S. Cl. CPC G06F 1/1607

(57) ABSTRACT

A display device comprises a display unit main body and a stand. The display unit main body includes a main-body-side fixing portion with a turn prevention portion. The stand includes a shaft with a stand-side engagement portion. The stand-side engagement portion is movable about an axis of the shaft relative to the display unit main body between a first turning position and a second turning position. The stand-side engagement portion is movable along the axis of the shaft while the stand-side engagement portion is located at the first turning position. The stand-side engagement portion is engageable with the main-body-side fixing portion while the stand-side engagement portion is located at the second turning position. The turn prevention portion prevents the stand-side engagement portion from moving from the second turning position to the first turning position while the stand-side engagement portion is located at the second turning position.

### CROSS-REFERENCE TO RELATED APPLICATIONS

This application claims priority to Japanese Patent Application No. 2023-144564 filed in Japan on Sep. 6, 2023. The entire disclosure of Japanese Patent Application No. 2023-144564 is hereby incorporated herein by reference.

### BACKGROUND

### Field of the Invention

The present invention relates to a display device, and specifically to a display device provided with a stand.

### Background Information

Display devices that have stands have been disclosed in the prior art (Japanese Laid-Open Patent Application Publication No. 2008-136160 (Patent Document 1), for example).

Patent Document 1 discloses a display device comprising a display unit main body that includes a display unit for displaying images and a stand that is disposed below the display main body and supports the display unit main body. The display device of this Patent Document 1 is configured such that the stand is attached to the display unit main body by fastening screws.

In addition, in the display device of Patent Document 1 described above, the stand is disposed to protrude farther forward and rearward than the display unit main body in the front-rear direction of the display unit main body, in order to stably support the display unit main body. Therefore, the length of the display device in the front-rear direction with the stand attached thereto increases by the length of the stand.

Here, while not disclosed in Patent Document 1, when a display device is packaged in a box, or the like, for transportation and storage, there are cases in which the display device is packaged in a state in which the stand is removed from the display unit main body so as not to increase the size of the packaging box. In this case, the user needs to attach the stand to the display unit main body when the user installs the display device at the delivery destination.

### SUMMARY

The display device of Patent Document 1 described above is configured such that the stand is attached to the display unit main body by fastening screws. Therefore, if it is necessary for the user to attach the stand to the display unit main body in order to install the display device, it is necessary to prepare a tool such as a screwdriver for fastening the screws. Therefore, there is the inconvenience that it is difficult for a user that does not possess a tool, such as a screwdriver, to attach the stand to the display unit main body. In addition, there are cases in which the stand needs to be removed from the display unit main body when reinstalling the installed display device, such as when redecorating or moving. Since screws need to be loosened in such a case, there is the inconvenience that it is difficult for a user that does not possess a tool, such as a screwdriver, to remove the stand from the display unit main body, similar to when attaching the stand. In addition, even if the user possesses a tool, such as a screwdriver, a plurality of screws must be fastened and loosened when attaching and removing the stand using the tool, so there is the inconvenience that the task of attaching and removing the stand to and from the display unit main body becomes complicated. As a result, there is a desire for the user to be able to easily attach and remove a stand to and from the display unit main body of a display device.

One object is to provide a display device in which the user can easily attach and remove a stand to and from a display unit main body.

In view of the state of the known technology, a display device comprises a display unit main body and a stand. The display unit main body has a display unit for displaying images. The display unit main body includes a main-body-side fixing portion with a turn prevention portion. The stand is attached to the main-body-side fixing portion of the display unit main body to support the display unit main body. The stand includes a shaft with a stand-side engagement portion. The stand-side engagement portion is movable about an axis of the shaft relative to the display unit main body between a first turning position and a second turning position. The stand-side engagement portion is movable along the axis of the shaft while the stand-side engagement portion is located at the first turning position. The stand-side engagement portion is engageable with the main-body-side fixing portion while the stand-side engagement portion is located at the second turning position. The turn prevention portion prevents the stand-side engagement portion from moving from the second turning position to the first turning position while the stand-side engagement portion is located at the second turning position to maintain the stand-side engagement portion at the second turning position.

### BRIEF DESCRIPTION OF THE DRAWINGS

FIG. 1 is a perspective view showing a display device according to an embodiment.

FIG. 2 is a side view showing the display device according to the embodiment.

FIG. 3 is a perspective view showing a stand of the display device according to the embodiment.

FIG. 4 is an enlarged perspective view showing a shaft portion of the stand of the display device according to the embodiment.

FIG. 5 is a plan view showing the shaft portion of the stand of the display device according to the embodiment.

FIG. 6 is an enlarged perspective view showing the shaft portion and a main-body-side fixing portion of the display device according to the embodiment, in a state in which a stand-side engagement portion is in a second turning position (engaged position) and is fixed to the main-body-side fixing portion.

FIG. 7 is a cross-sectional view showing a state in which the stand of the display device according to the embodiment is inserted in an insertion hole.

FIG. 8 is a plan view showing the shaft portion when the stand-side engagement portion of the display device according to the embodiment is in the second turning position (engaged position).

FIG. 9 is a cross-sectional view of the stand-side engagement portion taken along line IX-IX of FIG. 8.

FIG. 10 is a plan view showing the shaft portion when the stand-side engagement portion of the display device according to the embodiment is in a first turning position (non-engaged position).

FIG. 11 is a cross-sectional view of the stand-side engagement portion taken along line XI-XI of FIG. 10.

FIG. 12 is a side view showing the stand-side engagement portion and the main-body-side fixing portion when the display device according to the embodiment is not placed upright (laid on its side).

FIG. 13 is a side view showing the stand-side engagement portion and the main-body-side fixing portion when the display device according to the embodiment is placed upright and an engagement state between the stand-side engagement portion and a fall-off prevention portion is being maintained.

FIG. 14 is an enlarged perspective view showing the shaft portion and the main-body-side fixing portion in a state in which the stand-side engagement portion of the display device according to the embodiment is inserted in the insertion hole and is then positioned at the first turning position.

FIG. 15 is a perspective view showing a stand holder of the display device according to the embodiment as viewed from below.

FIG. 16 is a rear view showing the display device according to the embodiment.

FIG. 17 is an enlarged view showing a visual checking through-hole of a rear cover when the stand-side engagement portion of the display device according to the embodiment is not in the second turning position.

FIG. 18 is an enlarged view showing the visual checking through-hole of the rear cover when the stand-side engagement portion of the display device according to the embodiment is in the second turning position.

FIG. 19 is a diagram for explaining a procedure for attaching the stand of the display device according to the embodiment.

FIG. 20 is a side view showing a stand-side engagement portion and a main-body-side fixing portion of a display device according to a modification, illustrating a disengagement state between the stand-side engagement portions and a turn prevention portion.

FIG. 21 is a side view showing the stand-side engagement portion and the main-body-side fixing portion of the display device according to a modification, illustrating an engagement state between the stand-side engagement portion and a turn prevention portion.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

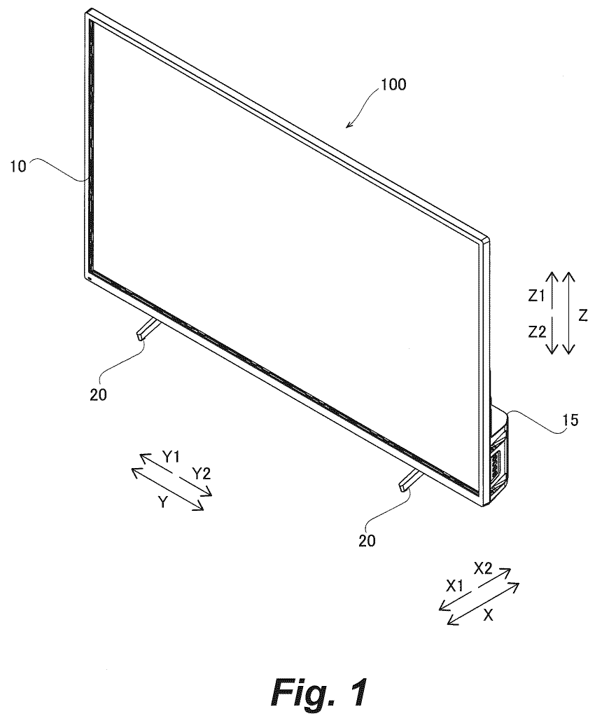

A configuration of a display device 100 according to an embodiment of the present disclosure will be described with reference to FIGS. 1-18. The display device 100 is a liquid crystal television device. Of course, the display device 100 is not limited to this. The display device 100 can be any other type of display device, such as a liquid crystal display, an OEL (organic electro-luminescence) television, an OEL display, etc.

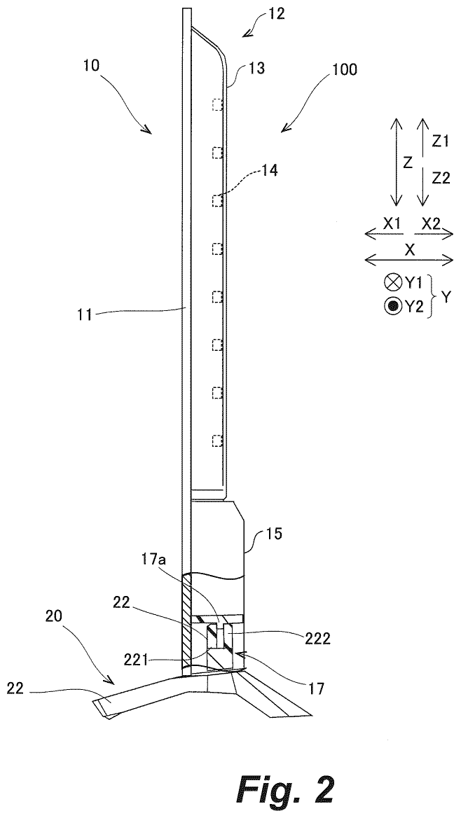

As shown in FIGS. 1 and 2, the display device 100 comprises a display unit main body 10 and a stand 20.

The display unit main body 10 has a function for displaying images. The display unit main body 10 comprises a display unit 11, a housing 12, a light source 14, and a rear cover 15. The display unit 11 is configured to display images using light from the light source 14. The display unit 11 includes a display panel with liquid crystal cells. The display unit 11 is configured to change the transmittance of light that is emitted from the light source 14 and that is transmitted through an optical member to display images.

The housing 12 is configured to house the light source 14. Specifically, the housing 12 includes a rear frame 13.

The rear frame 13 is formed of sheet metal or any other suitable material, as needed and/or desired. The rear frame 13 is provided on a rear side of the display unit 11.

The light source 14 is configured to irradiate light on the display unit 11. The light source 14 includes a plurality of LEDs (light emitting diodes) arranged on an inner surface of the rear frame 13 on the rear side of the display unit 11.

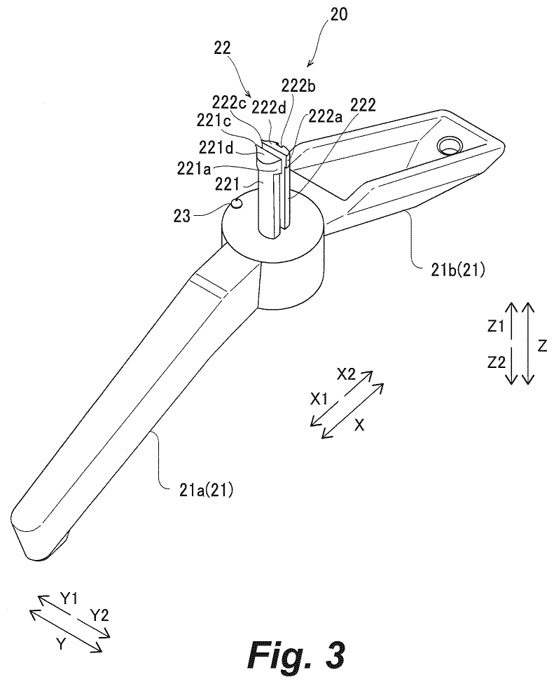

As shown in FIGS. 3-6, the stand 20 is made of resin and is provided with a leg portion or leg 21, a shaft portion or shaft 22, and a protruding portion or protrusion 23. The shaft portion 22 includes a plurality of (e.g., two) split shaft portions or split shafts 221 and 222, a second mark 222b, stand-side engagement portions 221a and 222a, guided portions 221c and 222c, and inclined surface portions or inclined surfaces 221d and 222d.

The leg portion 21 is configured to come into contact with the installation surface of the display device 100. The leg portion 21 is formed so as to protrude forward and rearward from the display unit main body 10. The leg portion 21 includes a front leg portion or leg 21a disposed on the front side (X1 direction side) and a rear leg portion or leg 21b disposed on the rear side (X2 direction side). The leg portion 21 is connected to the shaft portion 22.

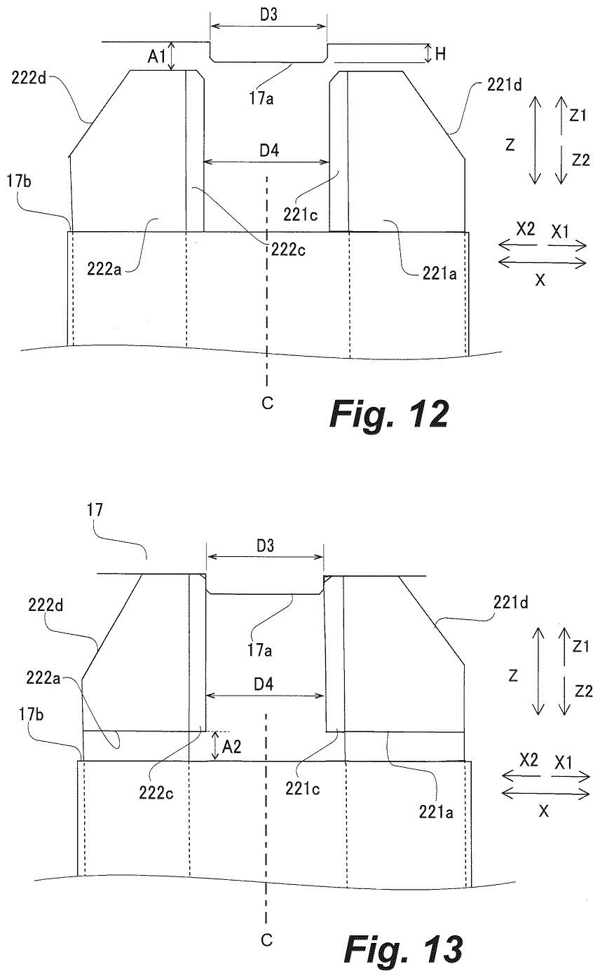

As shown in FIG. 3, the shaft portion 22 is formed extending in the up-down direction (Z direction) from the center of the stand 20 along its center axis C (e.g., an axis of the shaft portion 22) (see FIGS. 12 and 13).

The split shaft portions 221 and 222 has a shape formed by dividing the shaft portion 22 along its diameter (or the radial direction of the shaft portion 22). In addition, a plurality of the split shaft portions 221 and 222 are provided so as to be capable of being bent and deformed. For example, two of the split shaft portions 221 and 222 are provided. In addition, the split shaft portions 221 and 222 are configured such that, when the display unit main body 10 is placed upright in a state in which the stand-side engagement portions 221a and 222a are in a second turning position (an engaged position), load is applied between the display unit main body 10 and the stand 20 due to the weight of the display unit main body 10 itself, thereby maintaining the engagement state of the stand-side engagement portions 221a and 222a, and the stand-side engagement portions 221a and 222a are prevented from turning from the second turning position (the engaged position) to a first turning position (a non-engaged or disengaged position). For example, the second turning position (the engaged position) is a turning position that is shifted from the first turning position (the non-engaged position) by about 90 degrees. Upright here refers to a state or posture of the display unit main body 10 in which load is applied to the stand 20 in the vertical direction due to the weight of the display unit main body 10 itself. Thus, in the illustrated embodiment, the stand-side engagement portions 221a and 222a are movable about the center axis C of the shaft portion 22 relative to the display unit main body 10 between the first turning position and the second turning position.

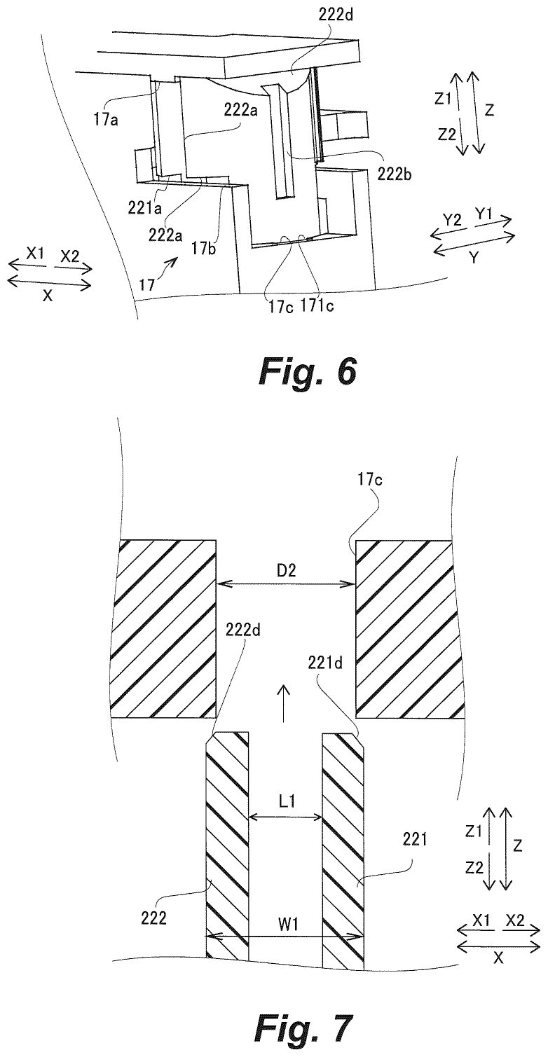

The stand-side engagement portions 221a and 222a have ribbed guided portions or ribs 221c and 222c that extend in the Z direction and that are provided on the distal end side of the shaft portion 22 of the stand 20. The stand-side engagement portions 221a and 222a can be turned to the first turning position (the non-engaged position) in which movement is possible in an insertion/removal direction (an insertion direction), and the second turning position (the engaged position), which is a position that is turned from the first turning position around a turning axis extending along the insertion/removal direction, and in which the stand-side engagement portions 221a and 222a are engaged with and fixed to a main-body-side fixing portion 17 that is made of resin. The stand-side engagement portions 221a and 222a engage with a fall-off prevention portion 17b when the stand 20 is inserted and is in the second turning position (see FIG. 6). When the display unit main body 10 is placed upright in a state in which the stand-side engagement portions 221a and 222a are in the second turning position (the engaged position), load is applied between the display unit main body 10 and the stand 20 due to the weight of the display unit main body 10 itself, thereby maintaining the engagement state with the fall-off prevention portion 17b. Thus, the stand-side engagement portions 221a and 222a are engageable with the main-body-side fixing portion 17 while the stand-side engagement portions 221a and 222a are located at the second turning position.

The second mark 222b is provided at the distal end of one of the split shaft portions 221 and 222 of the stand 20. In addition, the second mark 222b is for checking whether the stand 20 is in the second turning position (the engaged position) through a visual checking through-hole 18, when the stand 20 is attached to the display unit main body 10. Additionally, the second mark 222b is formed extending along the up-down direction (Z direction). In particular, the second mark 222b is provided on the split shaft portions 221 and 222 on the rear side (X2 direction side) (i.e., the split shaft portion 222), from among the plurality of split shaft portions 221 and 222. Additionally, the second mark 222b is formed in a groove shape that is recessed radially inward of the shaft portion 22. As a result, the second mark 222b can be integrally molded from resin when forming the stand 20, so the second mark 222b can be easily provided on the shaft portion 22 compared to a case in which the second mark 222b is provided later by printing, attaching a sticker, or the like.

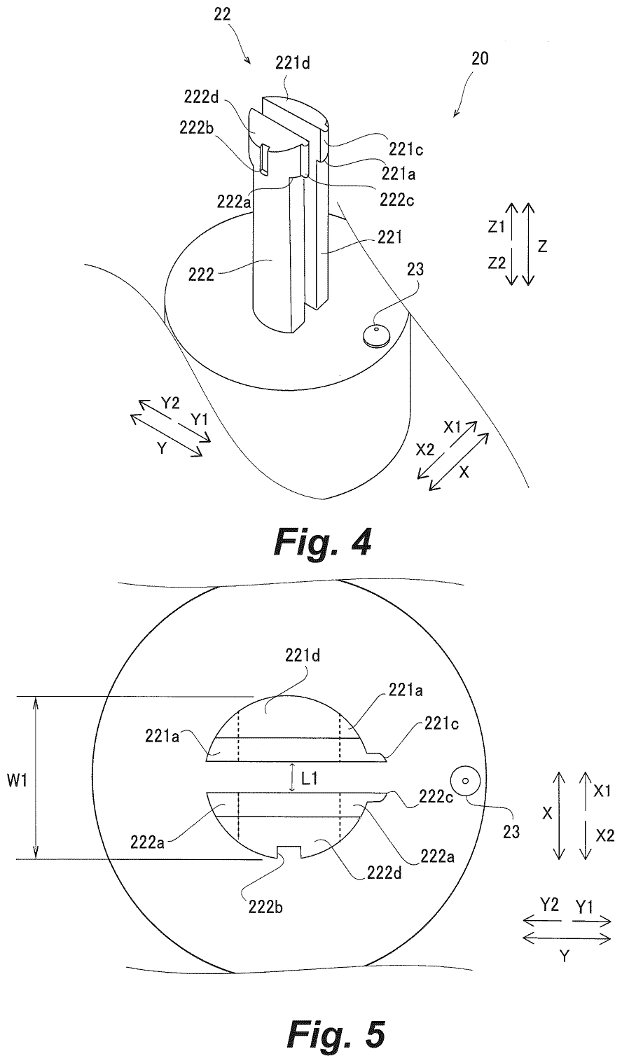

As shown in FIGS. 4-6, the guided portions 221c and 222c have a ribbed shape. The guided portions 221c and 222c are provided at the distal ends of the split shaft portions 221 and 222.

The inclined surface portions 221d and 222d are provided on the distal end portions of the split shaft portions 221 and 222, on a turn prevention portion 17a side. The inclined surface portions 221d and 222d are provided on end surfaces of the split shaft portions 221 and 222. The inclined surface portions 221d and 222d are inclined from top to bottom and from the internal diameter direction to the outer diameter direction of the split shaft portions 221 and 222. That is, the inclined surface portions 221d and 222d are tapered toward the distal end direction. When the inclined surface portions 221d and 222d are inserted in an insertion hole 17c, the split shaft portions 221 and 222 are deformed so as to bend radially inward. The shaft portion 22 (or the split shaft portions 221 and 222) is disposed in the insertion hole 17c whole the stand 20 is attached to the display unit main body 10.

The protruding portion 23 has a shape protruding in the insertion/removal direction (Z1 direction) of the stand 20. The protrusion 23 is formed in a dowel shape. When the stand 20 is fully inserted in the main-body-side fixing portion 17, the protruding portion 23 fits into a restricting and positioning groove 17d inside the display unit main body 10 (see FIG. 9). As a result of the protruding portion 23 fitting into the restricting and positioning groove 17d, the stand-side engagement portions 221a and 222a are guided so as to turn from the first turning position to the second turning position.

As shown in FIG. 7, the stand 20 of the display device 100 is inserted in the insertion hole 17c. The width W1 of the shaft portion 22 of the stand 20 is greater than the width D2 of the insertion hole 17c (W1>D2).

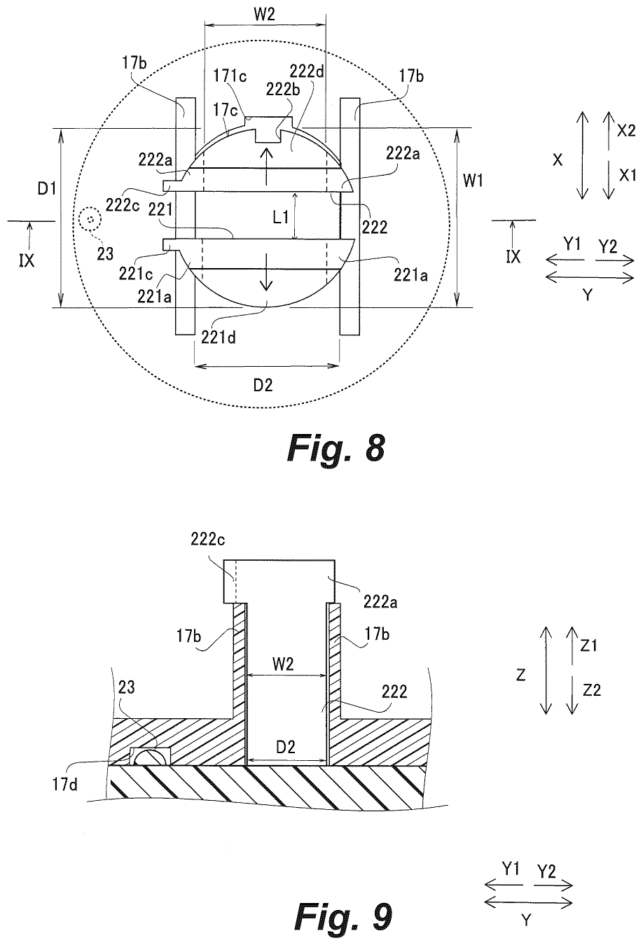

A state in which the stand-side engagement portions 221a and 222a are in each of the first and second turning positions will be described, with reference to FIGS. 8-12.

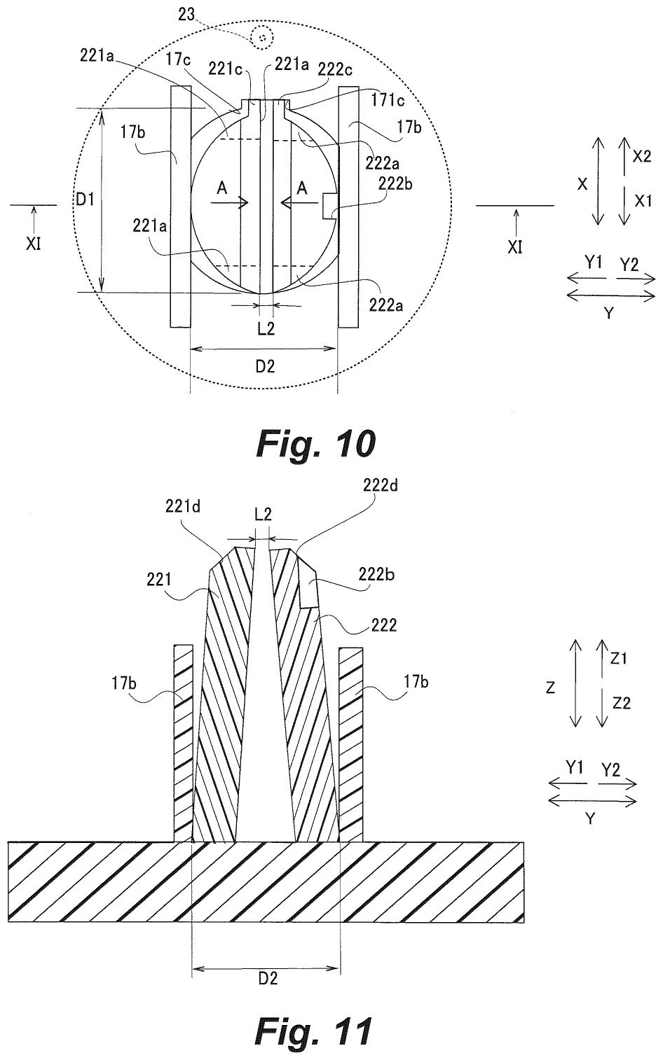

As shown in FIGS. 8 and 9, when the stand-side engagement portions 221a and 222a of the stand 20 are in the second turning position (the engaged position), the split shaft portions 221 and 222, which had been bent and deformed, are not bent and deformed radially inward (arrow A direction in FIG. 10). In addition, the stand-side engagement portions 221a and 222a engage with the fall-off prevention portion 17b.

As shown in FIGS. 10 and 11, when the stand-side engagement portions 221a and 222a of the stand 20 are in the first turning position and the shaft portion 22 of the stand is inserted in the insertion hole 17c, each of the pair of the split shaft portions 221 and 222 is bent and deformed radially inward (arrow A direction in FIG. 10). In addition, the guided portions 221c and 222c of the pair of the split shaft portions 221 and 222 are guided by a guide groove portion 171c in a state of being fitted therein. That is, the guide groove portion 171c guides the stand-side engagement portions 221a and 222a such that the stand 20 does not turn to the second turning position while the shaft portion 22 of the stand 20 is being inserted in the insertion hole 17c. Thus, the stand-side engagement portions 221a and 222a are movable along the center axis C of the shaft portion 22 while the stand-side engagement portions 221a and 222a are located at the first turning position. The shaft portion 22 (or split shaft portion 221a and 222) is movable along the center axis C of the shaft portion 22 while the stand-side engagement portion 221a and 222a are located at the first turning position. The shaft portion 22 includes the split shaft portions 221 and 222 that are separated relative to each other. The split shaft portions 221 and 222 are elastically deformed radially inward while the shaft portion 22 is being inserted in the insertion hole 17c.

The stand-side engagement portions 221a and 222a and the fall-off prevention portion 17b of the main-body-side fixing portion 17 when the display device 100 is not placed upright will be described, with reference to FIGS. 12 and 13.

As shown in FIG. 12, in a state in which the display device 100 is not placed upright, the stand 20 can be moved in the insertion direction (Z1 direction) with respect to the main-body-side fixing portion 17, such that a gap A1 that is greater than the height H of the turn prevention portion 17a is formed between the turn prevention portion 17a and the split shaft portions 221 and 222. In this case, the stand-side engagement portions 221a and 222a can be turned between the second turning position (the engaged position) and the first turning position (the non-engaged position). By further pushing the stand 20 in the Z1 direction at the second turning position (the engaged position), the main-body-side fixing portion 17 of the display unit main body 10 abuts against the upper end portion of the stand 20. As a result, the split shaft portions 221 and 222 engage with the turn prevention portion 17a in a state in which the stand-side engagement portions 221a and 222a are in the second turning position.

The stand-side engagement portions 221a and 222a and the fall-off prevention portion 17b of the main-body-side fixing portion 17 when the display device 100 is placed upright will be described, with reference to FIG. 13.

As shown in FIG. 13, when the display unit main body 10 is placed upright, the display device 100 moves in the Z2 direction due to the weight of the display unit main body 10 itself. At that time, the main-body-side fixing portion 17 and the shaft portion 22 abut against each other, creating a gap A2 between the fall-off prevention portion 17b and the stand-side engagement portions 221a and 222a. The gap A2 is about 0.5-1 mm in size, for example. In addition, the gap A2 is greater than the height H (refer to FIG. 12) of the turn prevention portion 17a. Additionally, the gap A2 is the same length as the gap A1, which is greater than the height H when the display device 100 is not placed upright. Thus, the turn prevention portion 17a prevents the stand-side engagement portions 221a and 222a from moving from the second turning position to the first turning position while the stand-side engagement portions 221a and 222a are located at the second turning position to maintain the stand-side engagement portions 221a and 222a at the second turning position. The turn prevention portion 17a prevents the stand-side engagement portions 221a and 222a from moving from the second turning position to the first turning position while the turn prevention portion 17a is engaged with the stand-side engagement portions 22. On the other hand, the turn prevention portion 17a allows the stand-side engagement portions 221a and 222a to move from the second turning position to the first turning position while the turn prevention portion 17a is disengaged with the stand-side engagement portions 221a and 222a. In particular, the turn prevention portion 17a prevents the stand-side engagement portions 221a and 222a from moving from the second turning position to the first turning position while the turn prevention portion 17a is engaged with the split shaft portions 221 and 222. In the illustrated embodiment, as seen in FIG. 12, the stand-side engagement portions 221a and 222a are disengaged from the turn prevention portion 17a while the stand-side engagement portions 221a and 222a is located at a first axial position (FIG. 12) along the center axis C of the shaft portion 22 relative to the display unit main body 10 to allow the stand-side engagement portions 221a and 222a to move between the first turning position and the second turning position. Furthermore, in the illustrated embodiment, as seen in FIG. 13, the stand-side engagement portions 221a and 222a are engaged with the turn prevention portion 17a while the stand-side engagement portions 221a and 222a are located at the second turning position and at a second axial position (FIG. 13) along the center axis C of the shaft portion 22 relative to the display unit main body 10 to prevent the stand-side engagement portions 221a and 222a from moving from the second turning position to the first turning position.

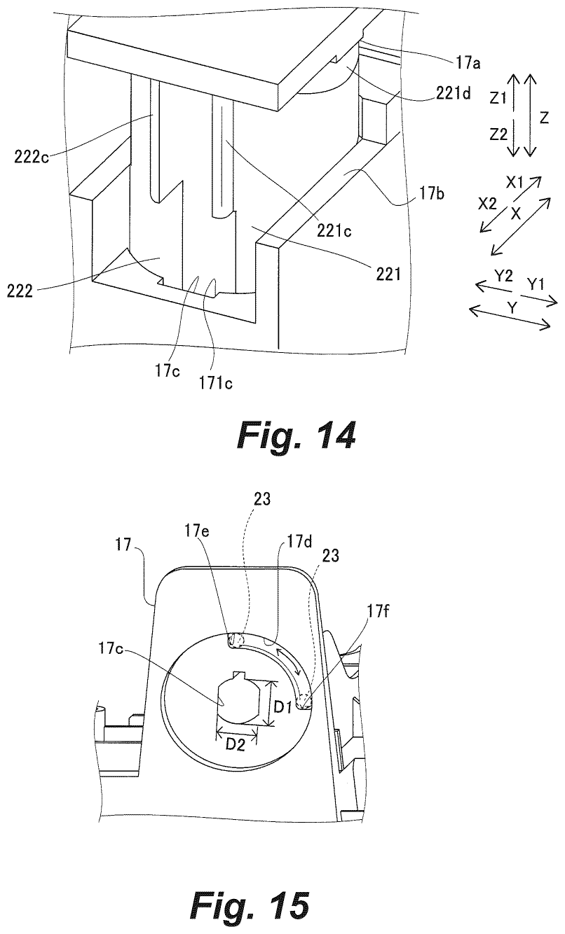

FIG. 14 shows the shaft portion 22 and the main-body-side fixing portion 17 when the stand-side engagement portions 221a and 222a of the display device 100 are in the first turning position (the non-engaged position (an insertion position)).

As shown in FIG. 15, the main-body-side fixing portion 17 has the insertion hole 17c and the restricting and positioning groove 17d.

The shaft portion 22 of the stand 20 is inserted in the insertion hole 17c. The insertion hole 17c is provided on a bottom surface of the main-body-side fixing portion 17.

The restricting and positioning groove 17d is provided on the bottom surface of the main-body-side fixing portion 17. The restricting and positioning groove 17d restricts the turning direction of the stand 20. The restricting and positioning groove 17d guides the protruding portion 23 of the stand 20 between one positioning end portion 17e corresponding to the first turning position at which the stand 20 can be inserted and removed, and an other positioning end portion 17f corresponding to the second turning position at which the stand 20 is fixed so as not to fall off. The restricting and positioning groove 17d is formed in an arc shape. The restricting and positioning groove 17d is formed in an arc shape having a central angle of about 90 degrees, for example.

The one positioning end portion 17e is disposed at an end portion on one side of the restricting and positioning groove 17d. The other positioning end portion 17f is disposed at an end portion on the other side of the restricting and positioning groove 17d. Thus, the main-body-side fixing portion 17 includes the restricting and positioning groove 17d in which the protruding portion 23 is disposed while the stand 20 is attached to the display unit main body 10 to position the stand 20 relative to the display unit main body 10 and restrict movement of the stand 20 relative to the display unit main body 10. Specifically, the restricting and positioning groove 17d has an arc shape that extends between a position (the one positioning end portion 17e) corresponding to the first turning position and a position (the other positioning end portion 17d) corresponding to the second turning position.

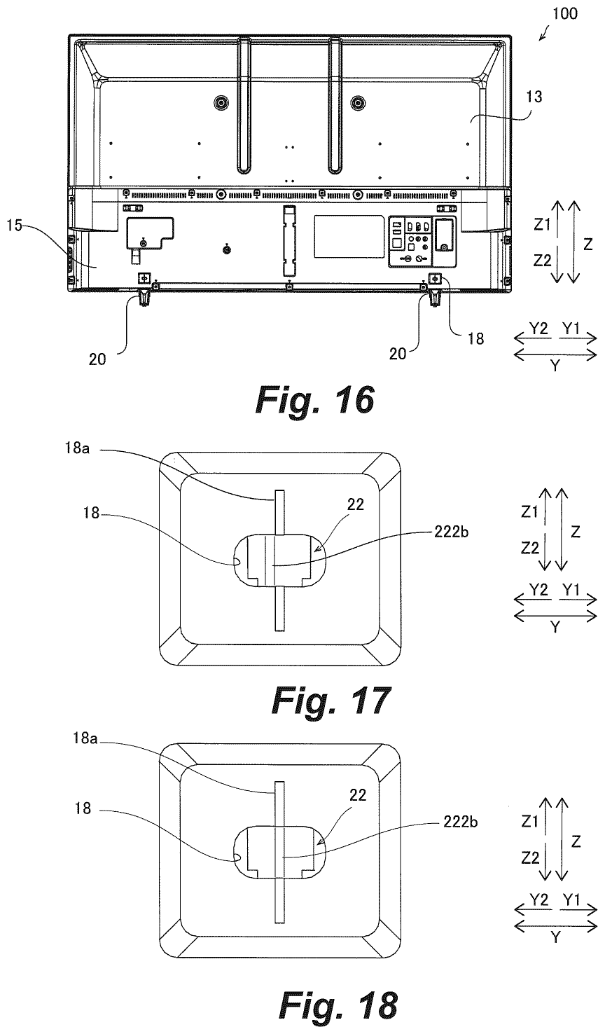

A method for checking the insertion position of the stand 20 through the visual checking through-hole 18 will be described, with reference to FIGS. 16-18.

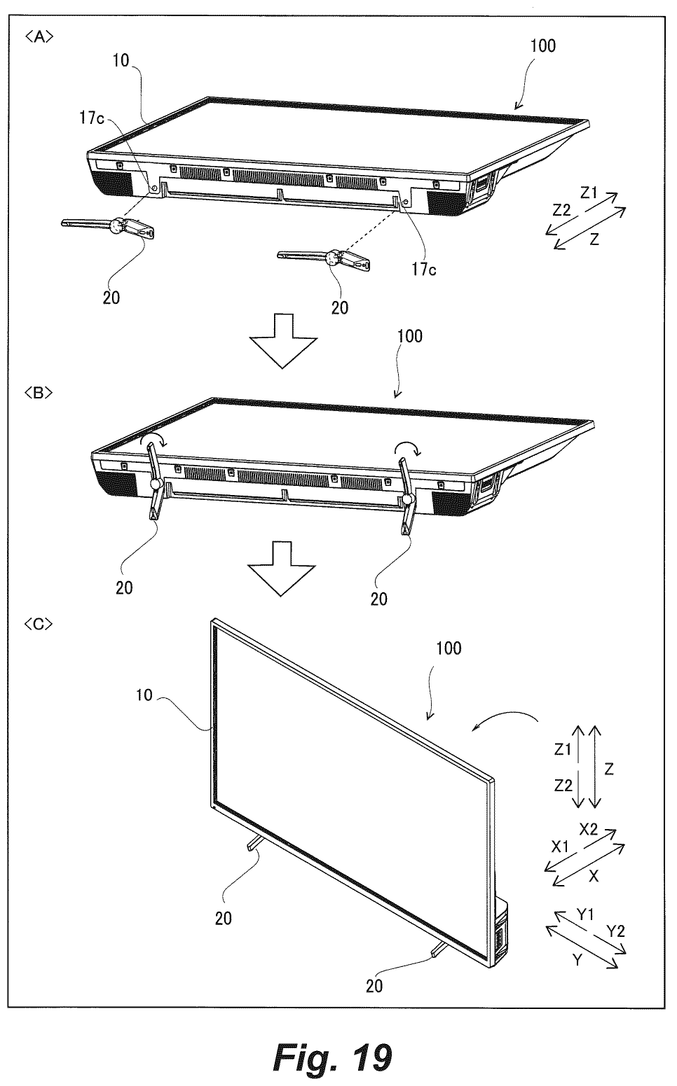

As shown in FIG. 16, the visual checking through-hole 18 is provided in a lower portion of the rear cover 15 on the rear side of the display device 100. In the illustrated embodiment, a pair of the visual checking through-holes 18 is provided along the left-right direction (Y direction) to correspond to a pair of the stands 20, respectively. The visual checking through-hole 18 is provided for checking whether the stand 20 has been correctly inserted after the insertion of the stand 20. That is, if the stand 20 is not fully inserted in the main-body-side fixing portion 17, the stand 20 cannot be seen through the visual checking through-hole 18. In addition, the visual checking through-hole 18 is provided for checking whether the stand-side engagement portions 221a and 222a of the stand 20 have been turned to the second turning position (the engaged position). Specifically, if the stand-side engagement portions 221a and 222a are not in the second turning position (the engaged position), a first mark 18a provided in the periphery of the visual checking through-hole 18 and the second mark 222b of the stand 20 are misaligned, as shown in FIG. 17. On the other hand, as shown in FIG. 18, if the stand-side engagement portions 221a and 222a are in the second turning position (the engaged position), the first mark 18a provided in the periphery of the visual checking through-hole 18 and the second mark 222b of the stand 20 are aligned in a straight line. The first mark 18a is provided in the periphery of the visual checking through-hole 18. The first mark 18a is provided in a straight line (Z direction) with respect to the visual checking through-hole 18. Thus, the display unit main body 10 is provided with the visual checking through-hole 18 and the first mark 18a that is provided in the periphery of the visual checking through-hole 18. The stand 20 includes the second mark 222b that is exposed through the visual checking through-hole 18 at a location corresponding to the first mark 18a while the stand-side engagement portions 221a and 222a are located at the second turning position.

An overview of a procedure for attaching the stand 20 to the display unit main body 10 will be explained, with reference to FIG. 19.

As seen in the portion (A) in FIG. 19, the stand 20 is inserted in the insertion hole 17c of the display unit main body 10 in a state in which the display unit main body 10 is laid on its side. At this time, the stand 20 is inserted in the display unit main body 10 in a state of being turned to the turning position of the main-body-side fixing portion 17 (the first turning position). Subsequently, as seen in the portion (B) in FIG. 19, the stand 20 is turned around a turning axis extending along the shaft portion 22. As a result, the stand-side engagement portions 221a and 222a are turned from the first turning position (the non-engaged position (the insertion position)) to the second turning position (the engaged position). In addition, the stand-side engagement portions 221a and 222a of the stand 20 are engaged with the turn prevention portion 17a of the display unit main body 10. Additionally, the stand 20 is fixed to the second turning position (the engaged position). Then, as seen in the portion (C) in FIG. 19, the display device 100 is placed upright. As a result, load is applied between the display unit main body 10 and the stand 20 due to the weight of the display unit main body 10 itself, and the engagement state of the stand-side engagement portions 221a and 222a is maintained, thereby preventing the stand-side engagement portions 221a and 222a from being turned from the second turning position (the engaged position) to the first turning position (the non-engaged position (the insertion position)). Thus, the turn prevention portion 17a prevents the stand-side engagement portions 221a and 222a from moving from the second turning position to the first turning position while the load is applied between the display unit main body 10 and the stand 20. On the other hand, the turn prevention portion 17a allows the stand-side engagement portions 221a and 222a to move from the second turning position to the first turning position while the load is not being applied between the display unit main body 10 and the stand 20. In the illustrated embodiment, the load is applied between the display unit main body 10 and the stand 20 due to the weight of the display unit main body 10 while the display device 100 is placed upright.

### Effects of the Present Embodiment

The following effects can be achieved in the present embodiment.

As described above, in the present embodiment, the turn prevention portion 17a is configured to prevent the stand-side engagement portions 221a and 222a from turning from the second turning position, in which the stand-side engagement portions 221a and 222a are engaged with and fixed to the display unit main body 10, to the first turning position, in which the stand-side engagement portions 221a and 222a can be moved in the insertion/removal direction, as a result of load being applied between the display unit main body 10 and the stand 20 due to the weight of the display unit main body 10 itself, by placing the display unit main body 10 upright in a state in which the stand-side engagement portions 221a and 222a are in the second turning position and are engaged with and fixed to the main-body-side fixing portion 17, thereby maintaining the engagement state of the stand-side engagement portions 221a and 222a. As a result, load is applied between the display unit main body 10 and the stand 20 due to the weight of the display unit main body 10 itself by placing the display unit main body 10 upright in a state in which the stand-side engagement portions 221a and 222a are put in the second turning position, thereby maintaining the engagement state of the stand-side engagement portions 221a and 222a, so that it is possible to prevent the stand 20 from falling off of the display unit main body 10. As a result, the user can insert the stand 20 in the main-body-side fixing portion 17 of the display unit main body 10, turn the stand-side engagement portions 221a and 222a from the first turning position to the second turning position, and place the stand 20 and the display unit main body 10 upright, to thereby attach the stand 20 to the display unit main body 10. As a result, it is not necessary to prepare a tool such as a screwdriver and the user can easily attach the stand 20 to the display unit main body 10. Additionally, the user can lay the stand 20 and the display unit main body 10 from the upright state, turn the stand-side engagement portions 221a and 222a from the second turning position to the first turning position, and pull the stand 20 out from the main-body-side fixing portion 17 of the display unit main body 10, to thereby remove the stand 20 from the display unit main body 10. As a result, the user can easily attach and remove the stand 20 to and from the display unit main body 10.

In addition, in the present embodiment, as described above, the stand 20 includes the leg portion 21 that comes in contact with the installation surface, and the shaft portion 22 that is connected to the leg portion 21 and that has the stand-side engagement portions 221a and 222a at a distal end thereof, and the turn prevention portion 17a is configured to fix the stand-side engagement portions 221a and 222a to the second turning position, as a result of load being applied between the display unit main body 10 and the stand 20 due to the weight of the display unit main body 10 itself, by placing the display unit main body 10 upright in a state in which the stand-side engagement portions 221a and 222a are in the second turning position and are engaged with and fixed to the main-body-side fixing portion 17, thereby maintaining the engagement state of the stand-side engagement portions 221a and 222a at the distal end side of the shaft portion 22. As a result, when the display unit main body 10 is placed upright, load is applied between the display unit main body 10 and the stand 20 due to the weight of the display unit main body 10 itself, thereby maintaining the engagement state between the turn prevention portion 17a and the stand-side engagement portions 221a and 222a on the distal end side of the shaft portion 22, so that the stand-side engagement portions 221a and 222a can be easily fixed to the second turning position. As a result, it is possible to easily prevent the stand 20 that has been attached from falling off of the display unit main body 10.

In addition, in the present embodiment, as described above, if the display unit main body 10 is not placed upright, the stand-side engagement portions 221a and 222a can release the engagement with the turn prevention portion 17a and can be turned from the second turning position to the first turning position in the disengaged state. As a result, when not in the upright state, as a result of the load between the display unit main body 10 and the stand 20 due to the weight of the display unit main body 10 itself not being applied to the stand-side engagement portions 221a and 222a, the engagement between the turn prevention portion 17a and the stand-side engagement portions 221a and 222a can be easily released, so that the stand-side engagement portions 221a and 222a can be easily turned from the second turning position to the first turning position. As a result, the stand 20 can be easily removed from the main-body-side fixing portion 17 in a state in which the stand-side engagement portions 221a and 222a are turned to the first turning position, so that the user can easily remove the stand 20 that had been attached to the display unit main body 10 from the main-body-side fixing portion 17.

In addition, in the present embodiment, as described above, the main-body-side fixing portion 17 comprises the insertion hole 17c in which the shaft portion 22 of the stand 20 is inserted so as to be movable when the stand-side engagement portions 221a and 222a are in the first turning position, the shaft portion 22 of the stand 20 comprises the plurality of split shaft portions 221 and 222 that are divided along the insertion/removal direction as well as in the radial direction of the shaft portion 22 and that can be bent and deformed, and is configured such that the split shaft portions 221 and 222 are bent and deformed radially inward when inserted in the insertion hole 17c, and the plurality of split shaft portions 221 and 222 is configured such that, when load is applied between the display unit main body 10 and the stand 20 due to the weight of the display unit main body 10 itself, by placing the display unit main body 10 upright in a state in which the stand-side engagement portions 221a and 222a are in the second turning position, thereby maintaining the engagement state of the stand-side engagement portions 221a and 222a, the stand-side engagement portions 221a and 222a are prevented from turning from the second turning position to the first turning position. As a result, the shaft portion 22 bends and deforms radially inward when inserting the stand 20, so that the shaft portion 22 can be easily inserted in the insertion hole 17c. In addition, the split shaft portions 221 and 222 divided into multiple parts prevent the stand-side engagement portions 221a and 222a from turning from the second turning position to the first turning position, so that the stand-side engagement portions 221a and 222a can be fixed to the second turning position by the split shaft portions 221 and 222, thus easily preventing the stand 20 from falling off.

In addition, in the present embodiment, as described above, the split shaft portions 221 and 222 of the stand 20 are provided with the inclined surface portions 221d and 222d that are tapered toward the distal end direction, at the distal end portion on the turn prevention portion 17a side. As a result, when inserting the split shaft portions 221 and 222 of the stand 20 into the insertion hole 17c of the main-body-side fixing portion 17, the split shaft portions 221 and 222 can be bent and deformed radially inward by inserting the inclined surface portions 221d and 222d of the distal end portion into the insertion hole 17c, so that the split shaft portions 221 and 222 can be easily inserted into the insertion hole 17c while being bent.

Additionally, in the present embodiment, as described above, the main-body-side fixing portion 17 includes the guide groove portion 171c that is provided in the insertion hole 17c and guides the stand-side engagement portions 221a and 222a of the stand 20 that is in the first turning position in the insertion/removal direction, and the guide groove portion 171c is configured to guide the guided portions 221c and 222c so that the stand 20 does not turn to the second turning position while the shaft portion 22 of the stand 20 is being inserted in the insertion hole 17c. As a result, it is possible to perform guidance so that the stand-side engagement portions 221a and 222a do not turn to the second turning position while being inserted into the insertion hole 17c, so that it is possible to prevent the stand-side engagement portions 221a and 222a from interfering with the main-body-side fixing portion 17 during insertion, making it impossible to be inserted. In addition, the front and rear of the stand 20 can be inserted correctly so that the stand 20 can be prevented from being inserted in the wrong direction.

In addition, in the present embodiment, as described above, the display unit main body 10 is provided with the visual checking through-hole 18 for visually checking the stand 20 that is fixed to the main-body-side fixing portion 17, the first mark 18a for confirming the turning position of the stand 20 is provided in the periphery of the visual checking through-hole 18, and the stand 20 includes the second mark 222b located at a position that corresponds to the first mark 18a, when in the second turning position. As a result, the position of the second mark 222b of the stand 20 relative to the first mark 18a provided in the periphery of the visual checking through-hole 18 can be checked through the visual checking through-hole 18, so that the user can easily confirm that the stand-side engagement portions 221a and 222a have been turned to the second turning position.

In addition, in the present embodiment, as described above, the stand 20 includes the protruding portion 23 that protrudes in the insertion/removal direction, the fixing portion includes the restricting and positioning groove 17d that engages with the protruding portion 23 and positions the stand 20 as well as restricting the turning direction thereof, and the restricting and positioning groove 17d is formed in an arc shape that connects between a position corresponding to the first turning position at which the stand 20 can be inserted and removed, and a position corresponding to the second turning position at which the stand 20 is fixed so as not to fall off. As a result, the front and rear of the stand 20 can be inserted correctly with respect to the display unit main body 10, so that the stand 20 can be prevented from being inserted in the wrong direction. In addition, one end corresponds to the first turning position and the other end corresponds to the second turning position, so that attachment is possible without mistaking positions at the time of insertion.

### Modifications

It should be noted that the embodiment disclosed above is an example in all respects and should not be construed as restrictive. The scope of the present invention is defined not by the above description of the embodiment but by the claims, and further includes the meaning that is equivalent that of the claims, as well as all modifications (modified examples) within the scope thereof.

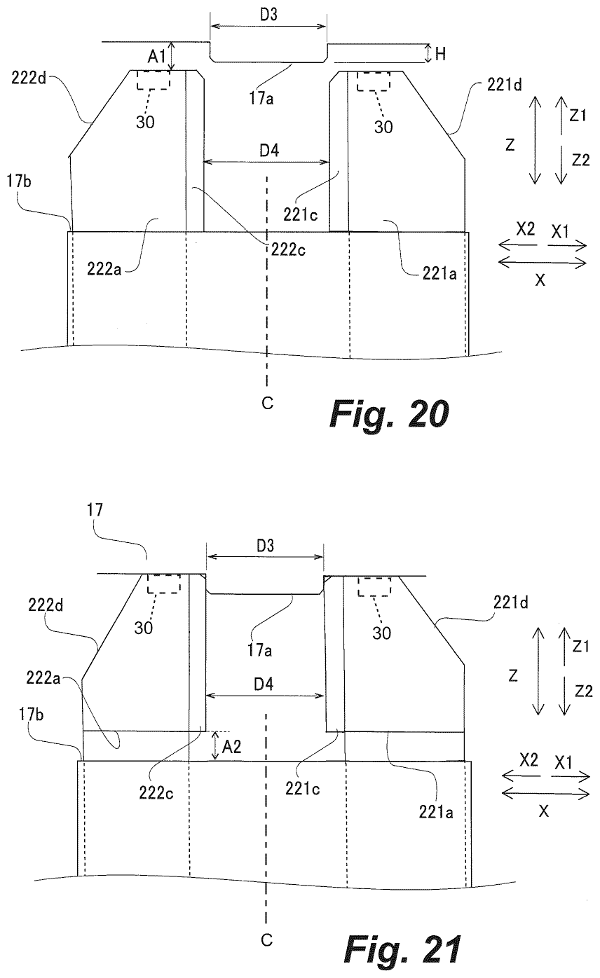

In the present embodiment, an example is presented in which, when the display unit main body 10 is placed upright in a state in which the stand-side engagement portions 221a and 222a are in the second turning position and are engaged with and fixed to the main-body-side fixing portion 17, load is applied between the display unit main body 10 and the stand 20 due to the weight of the display unit main body 10 itself, the engagement state of the stand-side engagement portions 221a and 222a is maintained, and the stand-side engagement portions 221a and 222a are prevented from turning from the second turning position to the first turning position, thereby preventing the stand 20 from falling off of the display unit main body 10, but the present disclosure is not limited thereto. As seen in FIGS. 21 and 22, the present disclosure may be configured such that, for example, one or more (two in FIGS. 21 and 22) magnets 30 are installed in or provided to at least one of the stand-side engagement portions 221a and 222a and the main-body-side fixing portion 17, and the magnetic force generated by the magnets 30 between the stand 20 and the display unit main body 10 may be used to apply load between the display unit main body and the stand to maintain the engagement state of the stand-side engagement portions 221a and 222a. In the illustrated embodiment, magnets 30 are embedded in upper surfaces of the stand-side engagement portions 221a and 222. Furthermore, in this case, a metallic plate made of a ferromagnetic material, such as an iron, is attached to a surface of the main-body-side fixing portion 17 that face the upper surface of the stand-side engagement portions 221a and 222a, or the surface of the main-body-side fixing portion 17 is made of a ferromagnetic material.

In this case, the magnets 30 may be an electromagnet, or a permanent magnet, such as a neodymium magnet or a ferrite magnet. In the illustrated embodiment, the magnets 30 are disposed on the upper surfaces of the shaft portion 22. However, the locations of the magnets 30 are not limited to this. one or more magnets can be disposed on or embedded in a surface of the insertion hole 17c that faces the shaft portion 22, a surface of an outer peripheral surface of the shaft portion 22, or an upper surface of the leg portion 21 that faces a lower surface of the main-body-side fixing portion 17. Additionally, load may be applied between the display unit main body and the stand using the attractive force of the magnet, or, load may be applied between the display unit main body and the stand using the repulsive force of the magnet.

In the present embodiment, an example is presented in which two stands are provided, but the present disclosure is not limited thereto. For example, one, or three or more stands may be provided in the present disclosure. In addition, at least one of a plurality of stands may be provided with the structure of the present disclosure.

Additionally, in the present embodiment, an example is presented in which the shaft portion 22 is divided into two split shaft portions 221 and 222, but the present disclosure is not limited thereto. For example, the shaft portion of the present disclosure may be divided into three or more split shaft portions. In this case, the turn prevention portion of the main-body-side fixing portion may also have a shape matching the divided shape of the split shaft portions.

In addition, in the present embodiment, an example is presented in which the guided portions 221c and 222c are formed in a ribbed shape, but the present disclosure is not limited thereto. The guided portions of the present disclosure may be formed in shapes other than a ribbed shape, such as a columnar shape.

Additionally, in the present embodiment, an example is presented in which the second mark 222b is configured as a recess, but the present disclosure is not limited thereto. The second mark of the present disclosure may be configured as a protrusion. In addition, a mark may be printed.

In addition, in the present embodiment, an example is presented in which the turn prevention portion 17a is formed in a convex shape extending in the radial direction, fitting between the two split shaft portions 221 and 222. In the present disclosure, it suffices if turning can be prevented, such as preventing turning by abutting against only one of the split shaft portions, rather than having a shape that fits into the split shaft portions.

Additionally, in the present embodiment, an example is presented in which the restricting and positioning groove 17d is formed in an arc shape of 90 degrees, but the present disclosure is not limited thereto. The positioning groove of the present disclosure may be formed in an arc shape of other than 90 degrees. For example, the positioning groove may be formed in an arc shape in the range of 30 degrees to 120 degrees, inclusive.

In addition, in the present embodiment, an example is presented in which the leg portion 21 extends in two directions, forward and rearward, but the present disclosure is not limited thereto. For example, the leg portion of the present disclosure may be formed to extend in three or more directions.

In view of the state of the known technology, a display device according to one aspect of the present invention comprises: a display unit main body that includes a display unit for displaying images; and a stand that is disposed below the display unit main body, and that supports the display unit main body and includes a stand-side engagement portion; wherein, the display unit main body includes a main-body-side fixing portion to which the stand is fixed, the stand-side engagement portion can be turned to a first turning position in which the stand-side engagement portion can be moved in an insertion/removal direction, and a second turning position, which is a position that is turned from the first turning position around a turning axis extending along the insertion/removal direction, and in which the stand-side engagement portion is engaged with and is fixed to the main-body-side fixing portion, the main-body-side fixing portion includes a turn prevention portion that prevents the stand from turning from the second turning position to the first turning position, and the turn prevention portion is configured to prevent the stand-side engagement portion from turning from the second turning position to the first turning position, as a result of load being applied between the display unit main body and the stand in a state in which the stand-side engagement portion is in the second turning position and is engaged with and fixed to the main-body-side fixing portion, thereby maintaining the engagement state of the stand-side engagement portion.

As described above, in the display device according to one aspect of the present disclosure, the turn prevention portion is configured to prevent the stand-side engagement portion from turning from the second turning position, in which the stand-side engagement portion is engaged with and fixed to the main-body-side fixing portion, to the first turning position, in which the stand-side engagement portion can be moved in the insertion/removal direction, as a result of load being applied between the display unit main body and the stand in a state in which the stand-side engagement portion is in the second turning position and is engaged with and fixed to the main-body-side fixing portion, thereby maintaining the engagement state of the stand-side engagement portion. As a result, load is applied between the display unit main body and the stand in a state in which the stand-side engagement portion is put in the second turning position, thereby maintaining the engagement state of the stand-side engagement portion, so that it is possible to prevent the stand from falling off of the display unit main body. As a result, the user can insert the stand in the main-body-side fixing portion of the display unit main body, turn the stand-side engagement portion from the first turning position to the second turning position, and then apply load between the display unit main body and the stand, to thereby attach the stand to the display unit main body. The user can thereby easily attach the stand to the display unit main body without using a tool, such as a screwdriver. In addition, since it is not necessary to fasten a plurality of screws using a tool, it is possible to prevent the task of attaching a stand to the display unit main body from becoming complicated. Additionally, the user can put the stand in a state in which there is no load applied between the display unit main body and the stand, turn the stand-side engagement portion from the second turning position to the first turning position, and pull the stand out of the main-body-side fixing portion of the display unit main body, to thereby remove the stand from the display unit main body. As a result, the user can easily remove the stand from the display unit main body without using a tool, such as a screwdriver. In addition, since it is not necessary to fasten and loosen a plurality of screws when attaching and removing the stand using a tool, it is possible to prevent the task of attaching and removing the stand to and from the display unit main body from becoming complicated. As a result, the user can easily attach and remove the stand to and from the display unit main body.

In accordance with a preferred embodiment according to the display device mentioned above, the stand preferably includes a leg portion that comes in contact with an installation surface, and a shaft portion that is connected to the leg portion and that has the stand-side engagement portion at a distal end thereof, and the turn prevention portion is preferably configured to fix the stand-side engagement portion to the second turning position, as a result of load being applied between the display unit main body and the stand in a state in which the stand-side engagement portion is in the second turning position and is engaged with and fixed to the main-body-side fixing portion, thereby maintaining the engagement state of the stand-side engagement portion at the distal end side of the shaft portion. With this configuration, load is applied between the display unit main body and the stand, thereby maintaining the engagement state between the turn prevention portion and the stand-side engagement portion on the distal end side of the shaft portion, so that the stand-side engagement portion can be easily fixed to the second turning position. As a result, it is possible to easily prevent the stand that has been attached from falling off of the display unit main body.

In this case, preferably, if load is not being applied between the stand-side engagement portion and the stand, the engagement with the turn prevention portion can be released, and the stand-side engagement portion can be turned from the second turning position to the first turning position in the disengaged state. With this configuration, as a result of load between the display unit main body and the stand not being applied to the stand-side engagement portion, the engagement between the turn prevention portion and the stand-side engagement portion can be easily released, so that the stand-side engagement portion can be easily turned from the second turning position to the first turning position. As a result, the stand can be easily removed from the main-body-side fixing portion in a state in which the stand-side engagement portion is turned to the first turning position, so that the user can easily remove, from the display unit main body, the stand that had been attached to the display unit main body.

In the display device having the configuration in which the stand includes a leg portion and a shaft portion, preferably, the main-body-side fixing portion comprises an insertion hole in which the shaft portion of the stand is inserted so as to be movable when the stand-side engagement portion is in the first turning position, the shaft portion of the stand comprises a plurality of split shaft portions that are divided along the insertion/removal direction as well as in a radial direction of the shaft portion and that can be bent and deformed, and is configured such that the split shaft portions are bent and deformed radially inward when inserted in the insertion hole, and the plurality of split shaft portions is configured such that, when load is applied between the display unit main body and the stand in a state in which the stand-side engagement portion is in the second turning position, the stand-side engagement portion is prevented from turning from the second turning position to the first turning position as a result of the plurality of split shaft portions being engaged with the turn prevention portion and load being applied between the display unit main body and the stand, thereby maintaining the engagement state of the stand-side engagement portion. With this configuration, the shaft portion bends and deforms radially inward when inserting the stand, so that the shaft portion can be easily inserted in the insertion hole. In addition, the split shaft portions divided into multiple parts engage with the turn prevention portion, thereby preventing the stand-side engagement portion from turning from the second turning position to the first turning position, so that the plurality of split shaft portions can be used to fix the stand-side engagement portion to the second turning position.

Preferably, in the display device according to the one aspect described above, when the display unit main body is placed upright in a state in which the stand-side engagement portion is in the second turning position and is engaged with and fixed to the main-body-side fixing portion, load is applied between the display unit main body and the stand due to the weight of the display unit main body itself, thereby maintaining the engagement state of the stand-side engagement portion. With this configuration, the stand can be placed upright to thereby easily apply load between the display unit main body and the stand using gravity.

Preferably, in the display device according to the one aspect described above, load is applied between the display unit main body and the stand due to magnetic force generated by a magnet provided on the stand-side engagement portion and/or the main-body-side fixing portion in a state in which the stand-side engagement portion is in the second turning position and is engaged with and fixed to the main-body-side fixing portion, thereby maintaining the engagement state of the stand-side engagement portion. With this configuration, it is possible to easily apply load between the display unit main body and the stand using magnetic force.

In the display device comprising a stand in which the shaft portion is divided, the split shaft portions of the stand are preferably provided with inclined surface portions that are tapered toward the distal end direction at the distal end portion on the turn prevention portion side. With this configuration, when inserting the split shaft portions of the stand into the insertion hole of the main-body-side fixing portion, the split shaft portions can be bent and deformed radially inward by inserting the inclined surface portions of the distal end portion into the insertion hole, so that the split shaft portions can be easily inserted into the insertion hole while being bent.

In the display device configured such that the main-body-side fixing portion has an insertion hole, the fixing portion preferably includes a guide groove that is provided in the insertion hole and guides the engagement portion of the stand that is in the first turning position in the insertion/removal direction, and the guide groove is configured to guide the stand-side engagement portion so that the stand does not turn to the second turning position while the shaft portion of the stand is being inserted in the insertion hole. With this configuration, it is possible to perform guidance so that the stand-side engagement portion does not turn to the second turning position while being inserted into the insertion hole, so that the stand-side engagement portion can be prevented from interfering with the main-body-side fixing portion during insertion, making it impossible to be inserted. In addition, the turning position at which the stand can be inserted in the insertion hole can be uniquely positioned with the guide groove, so that the stand can be easily inserted in the insertion hole at a turning position at which the stand can be attached to the display unit main body, with the front and rear of the stand in the correct positions.

Preferably, in the display device according to the one aspect described above, the display unit main body is provided with a visual checking through-hole for visually checking the stand that is fixed to the main-body-side fixing portion, a first mark for confirming the turning position of the stand is provided in the periphery of the visual checking through-hole, and the stand includes a second mark located at a position that corresponds to the first mark, when in the second turning position. With this configuration, the position of the second mark of the stand relative to the first mark provided in the periphery of the visual checking through-hole can be checked through the visual checking through-hole, so that the user can easily confirm that the stand-side engagement portion has been turned to the second turning position.

Preferably, in the display device according to the one aspect described above, the stand includes a protruding portion that protrudes in the insertion/removal direction, the fixing portion includes a restricting and positioning groove that engages with the protruding portion and positions the stand as well as restricts the turning direction thereof, and the restricting and positioning groove is formed in an arc shape that connects between a position corresponding to the first turning position at which the stand can be inserted and removed, and a position corresponding to the second turning position at which the stand is fixed so as not to fall off. With this configuration, the stand-side engagement portion can be turned from the first turning position to the second turning position so that the front and rear of the stand are correctly oriented with respect to the main body portion, so that the stand can be prevented from being turned in the wrong direction and being assembled with the front-rear direction of the stand oriented in the wrong direction. In addition, when the stand is turned, the stand-side engagement portion can be positioned at the second turning position by the restricting and positioning groove, so that the stand-side engagement portion can be reliably positioned at the second turning position.

With the display device of the present disclosure, a user can easily attach and remove a stand to and from a display unit main body.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a display device in an upright position on a horizontal surface. Accordingly, these directional terms, as utilized to describe the display device should be interpreted relative to a display device on a horizontal surface. The terms “left” and “right” are used to indicate the “right” when referencing from the right side as viewed from the rear side of the display device, and the “left” when referencing from the left side as viewed from the rear side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device, comprising:
a display unit main body having a display unit for displaying images, the display unit main body including a main-body-side fixing portion with a turn prevention portion; and
a stand attached to the main-body-side fixing portion of the display unit main body to support the display unit main body, the stand including a shaft with a stand-side engagement portion,
the stand-side engagement portion being movable about an axis of the shaft relative to the display unit main body between a first turning position and a second turning position, the stand-side engagement portion being movable along the axis of the shaft while the stand-side engagement portion is located at the first turning position, the stand-side engagement portion being engageable with the main-body-side fixing portion while the stand-side engagement portion is located at the second turning position,
the turn prevention portion preventing the stand-side engagement portion from moving from the second turning position to the first turning position while the stand-side engagement portion is located at the second turning position to maintain the stand-side engagement portion at the second turning position.

2. The display device according to claim 1, wherein
the turn prevention portion prevents the stand-side engagement portion from moving from the second turning position to the first turning position while load is applied between the display unit main body and the stand.

3. The display device according to claim 1, wherein,
the turn prevention portion allows the stand-side engagement portion to move from the second turning position to the first turning position while load is not being applied between the display unit main body and the stand.

4. The display device according to claim 1, wherein
the stand includes a leg portion that is configured to contact with an installation surface and is connected to the shaft.

5. The display device according to claim 1, wherein
the shaft has the stand-side engagement portion at a distal end thereof.

6. The display device according to claim 1, wherein
the turn prevention portion prevents the stand-side engagement portion from moving from the second turning position to the first turning position while the turn prevention portion is engaged with the stand-side engagement portion.

7. The display device according to claim 1, wherein
the turn prevention portion allows the stand-side engagement portion to move from the second turning position to the first turning position while the turn prevention portion is disengaged with the stand-side engagement portion.

8. The display device according to claim 1, wherein
the main-body-side fixing portion includes an insertion hole in which the shaft is disposed while the stand is attached to the display unit main body.

9. The display device according to claim 8, wherein
the shaft is movable along the axis of the shaft while the stand-side engagement portion is located at the first turning position.

10. The display device according to claim 8, wherein
the shaft includes a plurality of split shaft portions that are separated relative to each other, the split shaft portions being elastically deformed radially inward while the shaft is being inserted in the insertion hole.

11. The display device according to claim 10, wherein
the turn prevention portion prevents the stand-side engagement portion from moving from the second turning position to the first turning position while the turn prevention portion is engaged with the split shaft portions.

12. The display device according to claim 2, wherein,
the load is applied between the display unit main body and the stand due to a weight of the display unit main body while the display device is placed upright.

13. The display device according to claim 2, wherein
the load is applied between the display unit main body and the stand due to magnetic force of a magnet provided to at least one of the stand-side engagement portion and the main-body-side fixing portion.

14. The display device according to claim 10, wherein
the split shaft portions are provided with inclined surfaces that are tapered toward distal ends thereof.

15. The display device according to claim 10, wherein
the main-body-side fixing portion includes a guide groove that is provided in the insertion hole and guides the stand-side engagement portion while the shaft is being inserted in the insertion hole.

16. The display device according to claim 15, wherein
the guide groove guides the stand-side engagement portion while maintaining the stand-side engagement portion at the first turning position while the shaft is being inserted in the insertion hole.

17. The display device according to claim 1, wherein
the display unit main body is provided with a visual checking through-hole and a first mark that is provided in a periphery of the visual checking through-hole, and
the stand includes a second mark that is exposed through the visual checking through-hole at a location corresponding to the first mark while the stand-side engagement portion is located at the second turning position.

18. The display device according to claim 1, wherein
the stand includes a protruding portion, and
the main-body-side fixing portion includes a restricting and positioning groove in which the protruding portion is disposed while the stand is attached to the display unit main body to position the stand relative to the display unit main body and restrict movement of the stand relative to the display unit main body.

19. The display device according to claim 18, wherein
the restricting and positioning groove has an arc shape that extends between a position corresponding to the first turning position and a position corresponding to the second turning position.

20. The display device according to claim 1, wherein
the stand-side engagement portion is disengaged from the turn prevention portion while the stand-side engagement portion is located at a first axial position along the axis of the shaft relative to the display unit main body to allow the stand-side engagement portion to move between the first turning position and the second turning position, and
the stand-side engagement portion is engaged with the turn prevention portion while the stand-side engagement portion is located at the second turning position and at a second axial position along the axis of the shaft relative to the display unit main body to prevent the stand-side engagement portion from moving from the second turning position to the first turning position.
